(19) United States
(12) Patent Application Publication
(10) Pub. No.: US 2014/0267806 A1
(43) Pub. Date: Sep. 18, 2014

(54) DEVICE AND METHOD FOR PROCESSING VIDEO CONTENT

(71) Applicant: SONY CORPORATION, Tokyo (JP)

(72) Inventors: Sean Kennedy, San Diego, CA (US); Edward Winter, San Diego, CA (US)

(73) Assignee: SONY CORPORATION, Tokyo (JP)

(21) Appl. No.: 13/796,956

(22) Filed: Mar. 12, 2013

(51) Int. Cl. H04N 5/232

(52) U.S. Cl. CPC H04N 5/23251
USPC 348/208.3

(57) ABSTRACT

Various aspects of a device and a method for processing video content may comprise one or more processors. The one or more processors may determine, in run-time, a first set of pixel sensors of one or more image sensors that capture a first video content when the device is in a first orientation relative to a reference orientation. The one or more processors may determine a change in orientation of the device from the first orientation to a second orientation relative to the reference orientation. The second orientation is different from the first orientation. The one or more processors may determine, in run-time, a second set of pixel sensors of the one or more image sensors that capture a second video content when the device is in the second orientation. An orientation of the captured second video content is same as an orientation of the captured first video content.

### CROSS-REFERENCE TO RELATED APPLICATIONS/INCORPORATION BY REFERENCE

None.

### FIELD

Various embodiments of the disclosure relate to a digital camera. More specifically, various embodiments of the disclosure relate to a device and method for processing video content.

### BACKGROUND

With enhancements in quality of image sensors and advanced image processing techniques, digital cameras have gained immense popularity. Digital cameras may be available as a standalone unit and/or may be integrated into electronic devices, such as mobile phones and/or laptops. Moreover, the size and weight of digital cameras have reduced over the years. As a result, handling digital cameras, while capturing video, has become easier. A user may hold a digital camera in any orientation while capturing a video. However, the quality of captured video may be optimal when a user holds a digital camera in particular orientations while capturing a video.

Further limitations and disadvantages of conventional and traditional approaches will become apparent to one of skill in the art, through comparison of such systems with some aspects of the present disclosure as set forth in the remainder of the present application with reference to the drawings.

### SUMMARY

A device and a method for processing video content is described substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram of an exemplary apparatus for processing video content, in accordance with an embodiment of the disclosure.

FIG. 2A and FIG. 2B illustrate an example of processing video content, in accordance with an embodiment of the disclosure.

FIG. 3 is a flow chart illustrating exemplary steps for processing video content, in accordance with an embodiment of the disclosure.

### DETAILED DESCRIPTION

Various implementations may be found in a device and/or a method for processing video content. A video content processing device may determine, in run-time, a first set of pixel sensors of one or more image sensors that capture a first video content when the video content processing device is in a first orientation relative to a reference orientation. The video content processing device may determine a change in orientation of the video content processing device from the first orientation to a second orientation relative to the reference orientation. The second orientation is different from the first orientation. The video content processing device may determine, in run-time, a second set of pixel sensors of the one or more image sensors that capture a second video content when the video content processing device is in the second orientation. An orientation of the captured second video content relative to the reference orientation is same as an orientation of the captured first video content relative to the reference orientation.

The first video content and the second video content may correspond to a sequence of successive events being captured by the video content processing device. The video content processing device may generate one or more orientation signals indicative of the first orientation and the second orientation of the video content processing device. The video content processing device may determine the first orientation and the second orientation of the video content processing device based on the generated one or more orientation signals. The video content processing device may capture the video content in one or more of a square format, a rectangular format, and/or a circular format. The first orientation and the second orientation of the video content processing device may comprise one or more of a portrait orientation, a landscape orientation and/or an inclined orientation. The inclined orientation may correspond to an orientation of the video content processing device when the video content processing device is rotated at an angle relative to a reference axis.

The video content processing device may be a mobile phone. An orientation of a video content captured by the mobile phone relative to the reference orientation remains same when the mobile phone is rotated. The orientation of the video content captured by the mobile phone is one of a landscape orientation, a portrait orientation or an inclined orientation.

FIG. 1 is a block diagram of an exemplary apparatus for processing video content, in accordance with an embodiment of the disclosure. With reference to FIG. 1, there is shown a device 100. The device 100 may comprise a lens 102, one or more image sensors, such as an image sensor 104, one or more orientation sensors, such as an orientation sensor 106, an input/output (I/O) device 108, a memory 110, and one or more processors, such as a processor 112. The I/O device 108 may be optional as represented by dashed box in the block diagram of FIG. 1.

The device 100 may correspond to an electronic device capable of capturing and/or processing an image and/or a video content. The device 100 may comprise suitable logic, circuitry, interfaces, and/or code that may be operable to capture and/or process an image and/or a video content. Examples of the device 100 may include, but are not limited to, digital cameras, camcorders and/or electronic devices that have integrated digital cameras. Examples of such electronic devices may include, but are not limited to, mobile phones, laptops, tablet computers, Personal Digital Assistant (PDA) devices, and/or any other electronic device in which a digital camera may be incorporated.

The lens 102 may be an optical lens or an assembly of optical lenses. The lens 102 may comprise one or more lens elements. Each lens element directs the path of incoming light rays to re-create an image of an object on the image sensor 104.

The image sensor 104 may comprise suitable logic, circuitry, interfaces, and/or code that may be operable to capture an image and/or a video content. The image sensor 104 may be operable to capture an image and/or a video content in one or more of a square format, a rectangular format, and/or a circular format. Notwithstanding, the disclosure may not be limited and the image sensor 104 may capture an image and/or a video content in any format without limiting the scope of the disclosure.

The image sensor 104 may comprise an array of pixel sensors arranged in rows and columns. A pixel sensor is light sensitive and captures an image of an object via light received by the pixel sensor through the lens 102. A pixel sensor may convert a received optical image into a set of electrical signals. Accordingly, the image sensor 104 may generate a set of pixel signals representative of the captured image data. The set of pixel signals may be stored in the memory 110 after being processed by the processor 112.

The orientation sensor 106 may comprise suitable logic, circuitry, interfaces, and/or code that may be operable to detect the orientation of the device 100 relative to a reference orientation when the device 100 captures a video content. A reference orientation of the device may be a landscape orientation, a portrait orientation, and/or any other orientation. The orientation sensor 106 may detect whether the device 100 is held in a landscape orientation or in a portrait orientation. The orientation sensor 106 may further determine whether the device 100 is held in an inclined orientation. An inclined orientation may correspond to an orientation of the device 100 when an axis of the device 100 is rotated at an angle relative to a reference axis. For example, when the device 100 is in the landscape orientation, an axis of the device 100 may correspond to a reference axis. In an inclined orientation, an axis of the device 100 may be rotated at an angle relative to the axis of the device 100 when the device 100 is in the landscape orientation. For example, the axis of the device 100 may be rotated at an angle of 45 degrees relative to the axis of the device 100 when the device 100 is in landscape orientation. In another example, an axis of the device 100, when the device 100 is in the portrait orientation, may correspond to a reference axis. In an inclined orientation, an axis of the device 100 may be rotated at an angle relative to the axis of the device 100 when the device 100 is in the portrait orientation.

The orientation sensor 106 may be operable to generate one or more orientation signals in response to the detected orientation of the device 100. The generated one or more orientation signals may be indicative of the orientation of the device 100. The orientation sensor 106 may be operable to transmit the generated one or more orientation signals to the processor 112. Examples of the orientation sensor 106 may include, but are not limited to, mercury switches, an accelerometer, a gyroscope, a magnetometer, and/or any sensor operable to detect orientation of the device 100 and generate one or more orientation signals in response to the detected orientation.

The I/O device 108 may comprise various input and output devices that may be operably coupled to the processor 112. The I/O device 108 may comprise suitable logic, circuitry, interfaces, and/or code that may be operable to receive input from a user operating the device 100 and provide an output. Examples of input devices may include, but are not limited to, a keypad, a stylus, and/or a touch screen. Examples of output devices may include, but are not limited to, a display and a speaker. In an embodiment, an input device may be a capture button that initiates image and/or video content capture.

The memory 110 may comprise suitable logic, circuitry, interfaces, and/or code that may be operable to store a machine code and/or a computer program having at least one code section executable by the processor 112. Examples of implementation of the memory 110 may include, but are not limited to, Random Access Memory (RAM), Read Only Memory (ROM), Hard Disk Drive (HDD), and/or a Secure Digital (SD) card. The memory 110 may further be operable to store data, such as configuration settings of the device 100, the image sensor 104, and the orientation sensor 106. The memory may further store one or more images and/or video content captured by the device 100, one or more image processing algorithms, and/or any other data. The memory 110 may store one or more images and/or video contents in various standardized formats such as Joint Photographic Experts Group (JPEG), Tagged Image File Format (TIFF), Graphics Interchange Format (GIF), and/or any other format. The memory 110 may store a video content as a series of frames.

The processor 112 may comprise suitable logic, circuitry, and/or interfaces that may be operable to execute at least one code section stored in the memory 110. The processor 112 may be communicatively coupled to the image sensor 104, the orientation sensor 106, the I/O device 108, and the memory 110. The processor 112 may be implemented based on a number of processor technologies known in the art. Examples of the processor 112 may include, but are not limited to, an X86-based processor, a Reduced Instruction Set Computing (RISC) processor, an Application-Specific Integrated Circuit (ASIC) processor, and/or a Complex Instruction Set Computer (CISC) processor.

The processor 112 may be operable to receive data and/or signals from the image sensor 104, the orientation sensor 106, and the I/O device 108. The processor 112 may be operable to determine an orientation in which a user holds the device 100 relative to a reference orientation to capture a video content. The processor 112 may determine a change in the orientation of the device 100 when a user rotates the device 100 while capturing a video content. The processor 112 may determine the new orientation of the device 100 relative to the reference orientation after the rotation. The processor 112 may determine, in run-time, a set of pixel sensors of the image sensor 104 that are required to capture a video content when the device 100 is in the new orientation.

In an embodiment, the processor 112 may determine, in run-time, a set of pixel sensors that are required to capture a video content based on the orientation of the device 100 determined by the processor 112. In an embodiment, the processor 112 may determine, in run-time, a set of pixel sensors in such a manner that captured video content has a pre-defined orientation relative to the reference orientation. In an embodiment, a pre-defined orientation of a captured video content remains the same irrespective of the orientation of the device 100.

In operation, when a capture button of the device 100 is pressed, light reflected from an object may be captured by one or more pixel sensors of the image sensor 104. The one or more pixel sensors may generate a set of pixel signals representative of a captured image and/or video content. During or after capture of an image, the set of pixel signals may be transferred from the image sensor 104 to the memory 110. The memory 110 may store the received set of pixel signals as a set of frames. The processor 112 may process the set of frames to reconstruct a captured image and/or video content. The processor 112 may perform various image processing operations on the set of frames, such as color estimation and interpolation. The processor 112 may further arrange or format the set of frames into an image object conforming to a pre-defined standard format, such as JPEG or GIF, and/or data compression. The processed set of frames may be transferred to the memory 110 and stored as image and/or video content data. The stored image and/or video content data may be viewed on a display screen. In an embodiment, a display screen may be integrated within the device 100. In another embodiment, the stored image and/or video content data may be displayed on a display screen external to the device 100. Examples of such display screens may be a computer monitor and/or a display screen of a television.

In an embodiment, a user may hold the device 100 in a first orientation relative to a reference orientation to capture a first video content. The orientation sensor 106 may detect that the device 100 is held in the first orientation relative to a reference orientation. The orientation sensor 106 may generate one or more first orientation signals that may be indicative of the detected first orientation. The orientation sensor 106 may transmit the generated one or more first orientation signals to the processor 112. The processor 112 may determine that the device 100 is currently in a first orientation, based on the one or more first orientation signals. The processor 112 may determine, in run-time, a first set of pixel sensors required to capture the first video content in a pre-defined orientation relative to a reference orientation when the device 100 is in the first orientation. The determined first set of pixel sensors may capture a video content when the device 100 is in the first orientation. In an embodiment, a user may rotate the device 100 relative to a reference axis while capturing the first video content from a first orientation to a second orientation relative to the reference orientation. The second orientation is different from the first orientation. When the device 100 is in the second orientation, the orientation sensor 106 may generate one or more second orientation signals that may be indicative of the second orientation. Based on the one or more second orientation signals that correspond to the second orientation, the processor 112 may determine that the device 100 is currently oriented in the second orientation. Thus, the processor 112 may determine a change in the orientation of the device 100. The processor 112 may determine, in run-time, a second set of pixel sensors required to capture a second video content when the device 100 is in the second orientation. The first video content and the second video content may correspond to a sequence of successive events being captured by the device 100. The determined second set of pixel sensors may capture a second video content when the device 100 is in the second orientation. In an embodiment, the processor 112 may determine the second set of pixel sensors in such a way that the orientation of the captured first video content is the same as the orientation of the captured second video content.

In an embodiment, the device 100 may be a digital camera. Conventionally, a user may hold a digital camera in a landscape orientation to capture a video content. In a landscape orientation, a digital camera may capture a video content that is in a landscape orientation. The processor 112 may determine that the digital camera is currently in landscape orientation while capturing the video content. The processor 112 may determine, in run-time, a first set of pixel sensors that may be required to capture a first video content in the landscape orientation. Using the determined first set of pixel sensors, the processor 112 may capture the first video content that is in the landscape orientation. While capturing the video content, the user may rotate the digital camera clockwise and/or counterclockwise relative to a reference axis. Responsive to the rotation, the orientation of the digital camera may change to an orientation different from the landscape orientation. After rotating the digital camera, the user may hold the digital camera in a portrait orientation. The processor 112 may determine that the orientation of the digital camera has changed from landscape to portrait. The processor 112 may determine that the digital camera is currently in a portrait orientation. When the digital camera is in the portrait orientation, the processor 112 may determine, in run-time, a second set of pixel sensors required to capture a second video content. The processor 112 may determine the second set of pixel sensors in such a manner that the captured second video content remains in the landscape orientation, even when the digital camera is in the portrait orientation. The orientation of the captured second video content is the same as the orientation of the captured first video content. Thus, the orientation of a video content captured by the digital camera remains the same when the digital camera is rotated. Notwithstanding, the disclosure may not be so limited and the digital camera may capture a video content that is oriented in a portrait orientation and/or an inclined orientation without limiting the scope of the disclosure.

In another embodiment, the device 100 may be a mobile phone with an integrated camera. Conventionally, a user may hold a mobile phone in portrait orientation to capture a video content. The processor 112 may determine that the mobile phone is currently in the portrait orientation while capturing a first video content. The processor 112 may determine, in run-time, a first set of pixel sensors that may be required to capture the video content in a landscape orientation when the mobile phone is in the portrait orientation. Using the determined first set of pixel sensors, the processor 112 may capture the first video content that is in the landscape orientation. While capturing the first video content, the user may rotate the mobile phone clockwise and/or counter-clockwise relative to a reference axis. Responsive to the rotation, the orientation of the mobile phone may change to an orientation different from the portrait orientation. After rotating the mobile phone, the user may hold the mobile phone in a landscape orientation. The processor 112 may determine that the orientation of the mobile phone has changed from portrait to landscape. The processor 112 may determine that the mobile phone is now in the landscape orientation. When the mobile phone is in the landscape orientation, the processor 112 may determine, in run-time, a second set of pixel sensors required to capture a second video content. The processor 112 may determine the second set of pixel sensors in such a manner that a captured second video content remains in the landscape orientation, even when the digital camera is in landscape orientation. Thus, an orientation of the first video content captured when the mobile phone is in the portrait orientation is the same as an orientation of the second video content captured when the mobile phone is in the landscape orientation. The orientation of a video content captured by the mobile phone remains the same when the mobile phone is rotated. As a result, a video content captured by a mobile phone may always be oriented in a landscape orientation, irrespective of the orientation of the mobile phone. Notwithstanding, the disclosure may not be so limited and the mobile phone may capture a video content that is oriented in a portrait orientation and/or an inclined orientation without limiting the scope of the disclosure.

In an embodiment, a first orientation and a second orientation of the device 100 may be a landscape orientation, a portrait orientation, and/or an inclined orientation. The inclined orientation may correspond to an orientation of the device 100 when the device 100 may be rotated at an angle relative to a reference axis. In an embodiment, an orientation of captured video content may be a landscape orientation, a portrait orientation, and/or an inclined orientation. In the inclined orientation, the captured video content may be rotated at an angle relative to a reference axis.

In an embodiment, a reference orientation of the device 100 may correspond to any orientation of the device 100. For example, a landscape orientation, a portrait orientation and/or an inclined orientation of the device 100 may correspond to a reference orientation. In an embodiment, a user may specify a particular orientation of the device 100 that may correspond to a reference orientation. In another embodiment, the processor 112 may select a particular orientation of the device 100 as a reference orientation based on a duration for which the device 100 may remain in the particular orientation. In an embodiment, the processor 112 may determine a particular orientation as a reference orientation when the device 100 remains in the particular orientation for a duration more than a pre-determined duration. In an embodiment, a user may define the pre-determined duration. In another embodiment, the pre-determined duration may be defined by a manufacturer of the device 100 as a configuration setting of the device 100. In another embodiment, a reference orientation may be pre-defined by a manufacturer of the device 100 as a configuration setting of the device 100. In another embodiment, an orientation of the device 100 at a time when the device 100 is switched on may correspond to a reference orientation. In another embodiment, an orientation of the device 100 in which a first video content is captured may correspond to a reference orientation. In such a case, a first orientation of the device 100 may correspond to a reference orientation.

In an embodiment, a user may change an orientation of the device 100 from a first orientation to a second orientation relative to a reference orientation and hold the device in the second orientation for a pre-determined duration. After the pre-determined duration, when the user may again rotate the device 100 from the second orientation to a third orientation. In such a case, the processor 112 may determine, in run-time, a third set of pixel sensors that correspond to the third orientation. The third set of pixel sensors may capture a third video content such that an orientation of the captured third video content is the same as the orientation of the captured first video content and the captured second video content. Thus, the orientation of a video content captured by the device 100 remains the same, irrespective of the orientation of the device 100.

In an embodiment, a user may rotate the device 100 relative to a reference axis to change the orientation of the device 100 from a first orientation to a second orientation relative to a reference orientation. During the rotation, there may be multiple intermediate orientations of the device 100 before the user may hold the device 100 finally in the second orientation. In an embodiment, the processor 112 may determine, in run-time, the multiple intermediate orientations of the device 100. The processor 112 may further determine multiple sets of pixel sensors that correspond to the multiple intermediate orientations. In an embodiment, the processor 112 may determine a particular orientation of the device 100 as the second orientation when the device 100 remains in the particular orientation for a duration more than a pre-defined duration. In an embodiment, a user may define the pre-defined duration. In another embodiment, the pre-defined duration may be defined by a manufacturer of the device 100 as a configuration setting of the device 100.

For example, when the device 100 may be rotated from a landscape orientation to a portrait orientation, there may be multiple inclined orientations of the device 100 before the device 100 is finally oriented in the portrait orientation. The processor 112 may determine, in run-time, the multiple inclined orientations and multiple sets of pixel sensors that correspond to the multiple inclined orientations.

In an embodiment, the processor 112 may present a user interface (UI) on a display of the device 100. The UI may provide one or more options to a user to specify a pre-defined orientation of a captured video content, a pre-determined duration that determines a reference orientation, and/or a reference orientation. The UI may further provide one or more options to a user to specify a pre-defined duration that determines a second orientation of the device 100. The UI may further provide one or more options to a user to customize configuration settings of the device 100. In another embodiment, a pre-defined orientation of a captured video content may be defined by a manufacturer of the device 100.

FIG. 2A and FIG. 2B illustrate an example of processing a video content, in accordance with an embodiment of the disclosure. The example of FIG. 2A and FIG. 2B is described in conjunction with elements from FIG. 1.

With reference to FIG. 2A and FIG. 2B, there is shown a three dimensional (3D) coordinate system 200. The 3D coordinate system comprises an X-axis 202, a Y-axis 204, and a Z-axis 206. With reference to FIG. 2A and FIG. 2B, there is shown the device 100. The device 100 is shown to be coplanar to X-Y plane. The device 100 may rotate in the X-Y plane about the Z-axis 206. In an example, the X-Y plane may correspond to a ground level. In such a case, the device 100 may be rotated about an axis perpendicular to the ground level or X-Y plane while capturing a video content.

With reference to FIG. 2A and FIG. 2B, the device 100 may comprise the image sensor 104. The image sensor 104 may comprise an array of one or more pixel sensors, such as a pixel sensor 210.

With reference to FIG. 2A, there is shown the device 100 oriented in a landscape orientation, such that an axis 212 of the device 100 (shown as AA′) may lie along the Y-axis 204. In an embodiment, the axis 212 may correspond to a reference axis 208. In an embodiment, the landscape orientation may correspond to a reference orientation. Notwithstanding, the disclosure may not be so limited and any axis and/or any other orientation may correspond to a reference axis and reference orientation respectively, without limiting the scope of the disclosure.

For example, the device 100 may capture a video content that is in a landscape orientation. Notwithstanding, the disclosure may not be so limited and the device 100 may capture a video content that is in a portrait orientation and/or an inclined orientation without limiting the scope of the disclosure. The processor 112 may determine, in run-time, a first set of first pixel sensors required to capture a video content that is in a landscape orientation. The determined first set of pixel sensors may comprise one or more pixel sensors, such as a pixel sensor 214. The determined first set of pixel sensors may capture a first video content that is in the landscape orientation.

In an embodiment, a user may rotate the device 100 about the Z-axis 206 while capturing a video content. Responsive to the rotation, the orientation of the device 100 may change, such that the axis 212 of the device 100 may be rotated at an angle from the reference axis 208.

With reference to FIG. 2B, there is shown the device 100 rotated from a landscape orientation. The device 100 may be rotated in such a manner that the axis 212 of the device 100 is rotated at an angle of 30 degrees from the reference axis 208. Notwithstanding, the disclosure may not be so limited and the device 100 may be rotated at any angle from the reference axis without limiting the scope of the disclosure. The device 100, when rotated, may capture a video content that is in the landscape orientation. The processor 112 may determine, in run-time, a second set of pixel sensors required to capture a second video content with an orientation same as that of the first video content captured when the device 100 is in the landscape orientation. The processor 112 may determine, in run-time, the second set of pixel sensors such that the second video content captured by the determined second set of pixel sensors is oriented in the landscape orientation. The determined second set of pixel sensors may comprise one or more pixel sensors, such as a pixel sensor 216. The determined second set of pixel sensors may capture a video content that is in the landscape orientation.

FIG. 3 is a flow chart illustrating exemplary steps for processing a video content, in accordance with an embodiment of the disclosure. With reference to FIG. 3, there is shown a method 300. The method 300 is described in conjunction with elements of FIG. 1.

Exemplary steps begin at step 302. At step 304, the processor 112 may determine a first orientation of the device 100 relative to a reference orientation. The processor 112 may determine the first orientation based on one or more orientation signals received from the orientation sensor 106. At step 306, the processor 112 may determine, in run-time, a first set of pixel sensors of the image sensor 104 that may capture a first video content when the device 100 is in the first orientation relative to a reference orientation. At step 308, the processor 112 may capture the first video content that has a pre-defined orientation when the device 100 is in the first orientation. At step 310, the processor 112 may determine whether the orientation of the device 100 has changed from the first orientation to a second orientation relative to the reference orientation. The second orientation is different from the first orientation. When the processor 112 determines that the orientation of the device 100 has changed from the first orientation to the second orientation, the method proceeds to step 312. At step 312, the processor 112 may determine, in run-time, a second set of pixel sensors of the image sensor 104 that capture a second video content when the device 100 is in the second orientation. At step 314, the processor 112 may capture the second video content when the device 100 is in the second orientation. The processor 112 may capture the second video content such that the orientation of the captured second video content is the same as the orientation of the captured first video content. The method 300 ends at step 316.

In accordance with an embodiment of the disclosure, a device 100 (FIG. 1) for processing video content may comprise one or more processors, such as a processor 112 (FIG. 1). The one or more processors may be operable to determine, in run-time, a first set of pixel sensors of one or more image sensors, such as an image sensor 104 (FIG. 1), that capture a first video content when the device 100 is in a first orientation relative to a reference orientation. The one or more processors may be operable to determine a change in orientation of the device 100 from the first orientation to a second orientation relative to the reference orientation. The second orientation is different from the first orientation. The one or more processors may be operable to determine, in run-time, a second set of pixel sensors of the one or more image sensors that capture a second video content when the device 100 is in the second orientation. An orientation of the captured second video content relative to the reference orientation is the same as orientation of the first video content relative to the reference orientation.

The first video content and the second video content may correspond to a sequence of successive events being captured by the device 100. The device 100 may further comprise one or more orientation sensors, such as an orientation sensor 106 (FIG. 1). The orientation sensor 106 may be operable to generate one or more orientation signals indicative of the first orientation and the second orientation of the device 100. The one or more processors may be operable to determine the first orientation and the second orientation of the device 100 based on the generated one or more orientation signals.

The one or more orientation sensors may comprise one or more of mercury switches, an accelerometer, a gyroscope, and/or a magnetometer. The device 100 may further comprise one or more image sensors. The one or more image sensors may be operable to capture the video content. The one or more image sensors are operable to capture the video content in one or more of a square format, a rectangular format, and/or a circular format. The first orientation and the second orientation of the device 100 may comprise one or more of a portrait orientation, a landscape orientation and/or an inclined orientation. The inclined orientation comprises an axis 212 (FIG. 2) of the device 100 being rotated at an angle relative to a reference axis 208 (FIG. 2).

The device 100 may be a mobile phone. An orientation of a video content captured by the mobile phone remains the same when the mobile phone is rotated. The orientation of the video content captured by the mobile phone is a landscape orientation.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps comprising determining, in run-time, a first set of pixel sensors of one or more image sensors that capture a first video content when a video content processing device is in a first orientation relative to a reference orientation. A change in orientation of the video content processing device from the first orientation to a second orientation relative to a reference orientation may be determined. The second orientation is different from the first orientation. A second set of pixel sensors of the one or more image sensors that capture a second video content when the video content processing device is in the second orientation may be determined, in run-time. The orientation of the captured second video content relative to the reference orientation is the same as the orientation of the captured first video content relative to the reference orientation.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A device for processing video content, said device comprising:
one or more processors being operable to:
determine, in run-time, a first set of pixel sensors of one or more image sensors that capture a first video content when said device is in a first orientation relative to a reference orientation;
determine a change in orientation of said device from said first orientation to a second orientation relative to said reference orientation, wherein said second orientation is different from said first orientation; and
determine, in run-time, a second set of pixel sensors of said one or more image sensors that capture a second video content when said device is in said second orientation, wherein an orientation of said captured second video content relative to said reference orientation is same as orientation of said first video content relative to said reference orientation.

2. The device of claim 1, wherein said first video content and said second video content correspond to a sequence of successive events being captured by said device.

3. The device of claim 1, further comprising one or more orientation sensors operable to generate one or more orientation signals indicative of said first orientation and said second orientation of said device.

4. The device of claim 3, wherein said one or more processors are operable to determine said first orientation and said second orientation of said device based on said generated one or more orientation signals.

5. The device of claim 3, wherein said one or more orientation sensors comprise one or more of: mercury switches, an accelerometer, a gyroscope, and/or a magnetometer.

6. The device of claim 1, further comprising said one or more image sensors operable to capture said video content operable to capture said video content in one or more of: a square format, a rectangular format, and/or a circular format.

7. The device of claim 1, wherein said first orientation and said second orientation of said device comprise one or more of: a portrait orientation, a landscape orientation and/or an inclined orientation.

8. The device of claim 7, wherein said inclined orientation corresponds to an orientation of said device when said device is rotated at an angle relative to a reference axis.

9. The device of claim 1, wherein said device is a mobile phone.

10. The device of claim 9, wherein orientation of a video content captured by said mobile phone relative to said reference orientation remains same when said mobile phone is rotated.

11. The device of claim 10, wherein said orientation of said video content captured by said mobile phone is a landscape orientation.

12. A method for processing video content, said method comprising:
in a video content processing device:
determining, in run-time, a first set of pixel sensors of one or more image sensors that capture a first video content when said video content processing device is in a first orientation relative to a reference orientation;
determining a change in orientation of said video content processing device from said first orientation to a second orientation relative to said reference orientation, wherein said second orientation is different from said first orientation; and
determining, in run-time, a second set of pixel sensors of said one or more image sensors that capture a second video content when said video content processing device is in said second orientation, wherein an orientation of said captured second video content relative to said reference orientation is same as an orientation of said captured first video content relative to said reference orientation.

13. The method of claim 12, wherein said first video content and said second video content correspond to a sequence of successive events being captured by said video content processing device.

14. The method of claim 12, further comprising generating one or more orientation signals indicative of said first orientation and said second orientation of said video content processing device.

15. The method of claim 14, further comprising determining said first orientation and said second orientation of said video content processing device based on said generated one or more orientation signals.

16. The method of claim 12, wherein said first orientation and said second orientation of said video content processing device comprise one or more of: a portrait orientation, a landscape orientation and/or an inclined orientation.

17. The method of claim 16, wherein said inclined orientation corresponds to an orientation of said video content processing device when said video content processing device is rotated at an angle relative to a reference axis.

18. The method of claim 12, wherein said video content processing device is a mobile phone.

19. The method of claim 18, wherein an orientation of a video content captured by said mobile phone relative to said reference orientation remains same when said mobile phone is rotated, wherein said orientation of said video content captured by said mobile phone is a landscape orientation.

20. A non-transitory computer readable medium, and/or storage medium, and/or a non-transitory machine-readable medium and/or storage medium, having stored thereon, a machine code and/or a computer program having at least one code section executable by a machine and/or a computer, thereby causing and machine and/or computer to perform steps comprising:
determining, in run-time, a first set of pixel sensors of one or more image sensors that capture a video content when a video content processing device is in a first orientation relative to a reference orientation;
determining a change in orientation of said video content processing device from said first orientation to a second orientation relative to said reference orientation, wherein said second orientation is different from said first orientation; and
determining, in run-time, a second set of pixel sensors of said one or more image sensors that capture said video content when said video content processing device is in said second orientation, wherein an orientation of said captured video content relative to said reference orientation is same when said video content processing device is in said first orientation and when said video content processing device is in said second orientation.
